(19) United States
(12) Patent Application Publication
(10) Pub. No.: US 2011/0135358 A1
(43) Pub. Date: Jun. 9, 2011

(54) FIXING DEVICE COMPRISING AUXILIARY HEAT GENERATING MEMBER AND MAINTAINING GAP RELATIVE TO SEPARATOR

(75) Inventors: Kazuhiko Kikuchi, Kanagawa (JP); Satoshi Kinouchi, Tokyo (JP); Shuji Yokoyama, Shizuoka (JP); Hiroyuki Kunugi, Shizuoka (JP); Hiroshi Nakayama, Shizuoka (JP); Yoshiaki Okano, Shizuoka (JP); Setsuo Takada, Shizuoka (JP); Toshihiro Sone, Kanagawa (JP)

(73) Assignees: Kabushiki Kaisha Toshiba, Tokyo (JP); Toshiba TEC Kabushiki Kaisha, Tokyo (JP)

(21) Appl. No.: 12/951,931

(22) Filed: Nov. 22, 2010

Related U.S. Application Data
(60) Provisional application No. 61/266,617, filed on Dec. 4, 2009.
(60) Provisional application No. 61/266,622, filed on Dec. 4, 2009.
(60) Provisional application No. 61/266,624, filed on Dec. 4, 2009.
(60) Provisional application No. 61/266,633, filed on Dec. 4, 2009.

(51) Int. Cl. G03G 15/20

(52) U.S. Cl. 399/329

(57) ABSTRACT

A fixing device includes a fixing belt comprising a first metal heat generating layer; a pressure section facing an outer periphery of the fixing belt; an induction current generating coil situated near a peripheral surface of the fixing belt; a nip forming member situated inside the fixing belt and applying pressure to the fixing belt toward the pressure section; and an auxiliary heat generating member situated inside the fixing belt, comprising a second metal heat generating layer, extending to a position facing the induction current generating coil, and comprising a projecting portion contacting the fixing belt.

### CROSS-REFERENCE TO RELATED APPLICATION

This application is based upon and claims the benefit of priority from Provisional U.S. Applications 61/266622 filed on Dec. 4, 2009, 61/266633 filed on Dec. 4, 2009, 61/266624 filed on Dec. 4, 2009 and 61/266617 filed on Dec. 4, 2009, the entire contents of which are incorporated herein by reference.

### FIELD

An embodiment relates to a fixing device for use in image forming apparatuses, which rapidly increases in temperature and prevents the occurrence of temperature variations.

### BACKGROUND

As a fixing device for use in image forming apparatuses such as copying machines or printers, there is a fixing device which uses a fixing belt whose heat generating layer is reduced in thickness to make a heat capacity small for saving energy and obtaining rapid temperature rise, and uses a pressure pad as a nip forming section.

Because of the small heat capacity, the fixing belt remarkably decreases in temperature due to the passage of a sheet. In addition, the heat capacity of the pressure pad itself is not small. Therefore, there is a risk that a heat quantity given to the fixing belt alone may not make up for a heat quantity which the fixing belt loses to the pressure pad. Since the fixing belt decreases in temperature also due to the pressure pad, the fixing belt generates temperature variations based on belt cycle. Because of the temperature variations of the fixing belt, there is a risk that the degradation of image quality such as, for example, gloss variations may occur on a sheet.

### BRIEF DESCRIPTION OF THE DRAWINGS

FIG. 1 is a schematic configuration view showing an MFP mounting a fixing unit of an embodiment;

FIG. 2 is a schematic configuration view of the fixing unit as viewed from a side thereof and a control block schematic view focusing on the fixing unit of the embodiment;

FIG. 3 is a schematic explanatory view showing temperature detection locations of a fixing belt of the embodiment;

FIG. 4 is a schematic explanatory view showing the layer configurations of the fixing belt and an auxiliary heat generating member of the embodiment;

FIG. 5 is a schematic explanatory view showing the configuration of a pressure pad of the embodiment;

FIG. 6 is a table showing material properties of the pressure pad of the embodiment;

FIG. 7 is a schematic explanatory view showing another exemplary layer configuration of the auxiliary heat generating member; and

FIG. 8 is a flowchart showing the control of the MFP of the embodiment.

### DETAILED DESCRIPTION

According to an embodiment, a fixing device includes a fixing belt comprising a first metal heat generating layer, a pressure section facing an outer periphery of the fixing belt, an induction current generating coil situated near a peripheral surface of the fixing belt, a nip forming member situated inside the fixing belt and applying pressure to the fixing belt toward the pressure section, and an auxiliary heat generating member situated inside the fixing belt, comprising a second metal heat generating layer, extending to a position facing the induction current generating coil, and comprising a projecting portion contacting the fixing belt.

Hereinafter, the embodiment will be described.

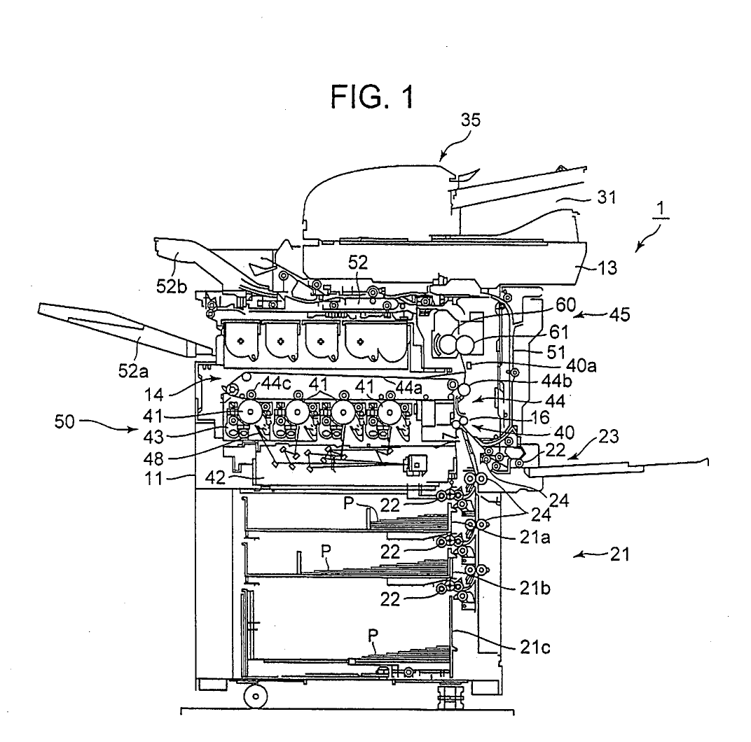

FIG. 1 is a schematic configuration view showing a multi functional peripheral (hereinafter simply referred to as MFP) 1 as an image forming apparatus mounting the fixing device of the embodiment. The MFP 1 includes a scanner section 13 which reads an image, a printer section 14 as an image forming section, a paper feeding section 21 which feeds a sheet P as a recording medium, and a paper discharging section 52 having a first tray 52a and a second tray 52b on each of which the sheet P discharged by the printer section 14 is stacked. The MFP 1 has a manual paper feeding section 23 on the side of a housing 11. The MFP 1 includes a conveying mechanism 40 of the sheet P from the paper feeding section 21 or the manual paper feeding section 23 through the printer section 14 to the paper discharging section 52.

The scanner section 13 scans an original document supplied by an auto document feeder (ADF) 35 to take image information. After completion of reading of the image information by the scanner section 13, the ADF 35 discharges the original document to a document discharging section 31.

The printer section 14 forms an image corresponding to input image information or the image information read by the scanner section 13 onto the sheet P. The printer section 14 includes four sets of image forming stations 50 of yellow (Y) , magenta (M) , cyan (C) , and black (K) , an exposure device 42, and a transfer unit 44 which transfers a toner image formed by the image forming stations 50 to the sheet P of any size. The printer section 14 includes a fixing unit 45 as a fixing device which fixes the toner image to the sheet P.

Each of the four sets of image forming stations 50 has the same structure, and includes a photoconductive drum 41, a charger 48 which uniformly charges the photoconductive drum 41, and a developing device 43 which develops an electrostatic latent image formed on the photoconductive drum 41 by irradiation of exposure light of the exposure device 42 after charging to form a toner image. The transfer unit 44 includes an intermediate transfer belt 44a, primary transfer rollers 44c, and a secondary transfer roller 44b.

The paper feeding section 21 includes an upper paper-feeding cassette 21a, a lower paper-feeding cassette 21b, and a large-capacity cassette 21c. The conveying mechanism 40 includes conveying rollers 24 and resist rollers 16 which supply the sheet P taken out by a pickup roller 22 from the paper feeding section 21 or the manual paper feeding section 23 to the transfer unit 44. The conveying mechanism 40 conveys the sheet P passed through the transfer unit 44 and the fixing unit 45 and having a fixed toner image to the paper discharging section 52 or a circulation path 51. The paper discharging section 52 discharges the sheet P onto the first tray 52a or the second tray 52b, or reverses the sheet P in a direction of the circulation path 51. The circulation path 51 guides the sheet P again to the transfer unit 44. The conveying mechanism 40 includes a sheet sensor 40a which detects the sheet P from the transfer unit 44 to the fixing unit 45.

Upon starting image formation, the MFP 1 charges the photoconductive drum 41 with the charger 48, and thereafter irradiates the photoconductive drum 41 with exposure light with the exposure device 42 to thereby form an electrostatic latent image corresponding to the exposure light on the photoconductive drum 41. The developing device 43 provides toner for the electrostatic latent image on the photoconductive drum 41 to visualize the electrostatic latent image. The transfer unit 44 transfers via the intermediate transfer belt 44a the toner image obtained by visualizing the electrostatic latent image on the photoconductive drum 41 onto the sheet P.

The sheet P supplied from the paper feeding section 21 or the manual paper feeding section 23 goes through the conveying mechanism 40 to reach a nip between the intermediate transfer belt 44a and the secondary transfer roller 44b, in synchronization with the toner image which is primarily transferred onto the intermediate transfer belt 44a. The secondary transfer roller 44b secondarily transfers the toner image on the intermediate transfer belt 44a onto the sheet P passing through the nip between the intermediate transfer belt 44a and the secondary transfer roller 44b. The fixing unit 45 fixes the toner image onto the sheet P. A paper discharge conveying section 52 discharges the sheet P having the toner image fixed thereon onto the first tray 52a or the second tray 52b. The circulation path 51 guides the sheet P having the toner image fixed thereon again to a direction of the secondary transfer roller 44b of the transfer unit 44.

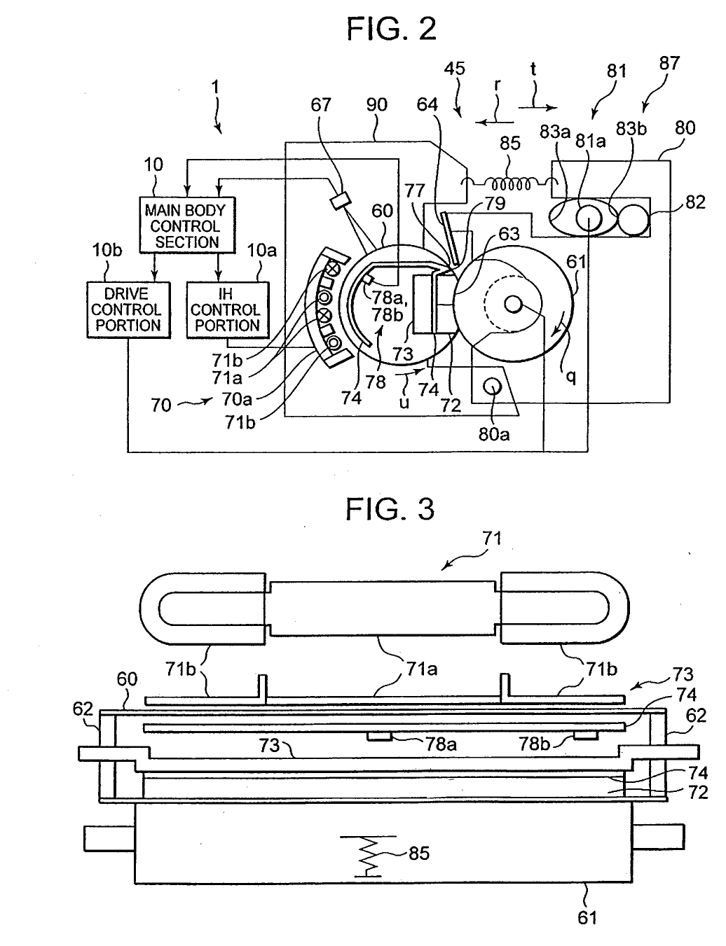

The fixing unit 45 will be next described. As shown in FIGS. 2 and 3, the fixing unit 45 includes a fixing belt 60, a press roller 61, an induction current generating coil (hereinafter simply referred to as IH coil) 70, a pressure pad 72 as a nip forming member, an auxiliary heat generating member 74, and a non-contact, thermopile type infrared temperature sensor 67.

The fixing unit 45 includes a separation blade 64 as a separation member on the sheet P discharge-side of a nip 63 on the periphery of the fixing belt 60.

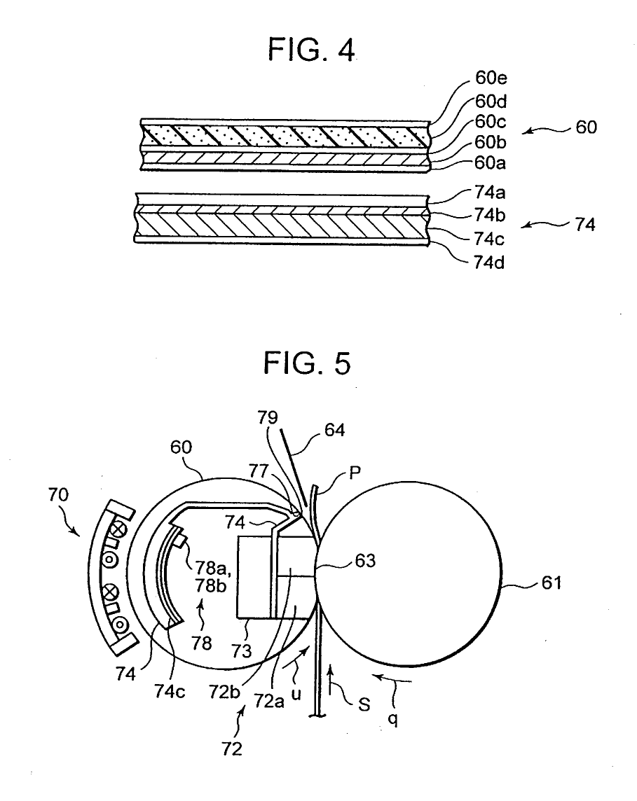

The fixing belt 60 has a multilayer structure. The fixing belt 60 includes, for example as shown in FIG. 4, a nickel (Ni) heat generating layer 60b with a thickness of 40 μm as a metal heat generating layer, an adhesion layer 60c with a thickness of 20 μm, a silicone rubber layer 60 with a thickness of 200 μm, and a fluororesin mold release layer 60e with a thickness of 30 μm, around a supporting layer 60a. The material of the heat generating layer 60b may be stainless steel, aluminum (Al), a composite material of stainless steel and aluminum, or the like. Flanges 62 support both sides of the fixing belt 60. The fixing belt 60 rotates following the press roller 61 integrally with the flanges 62.

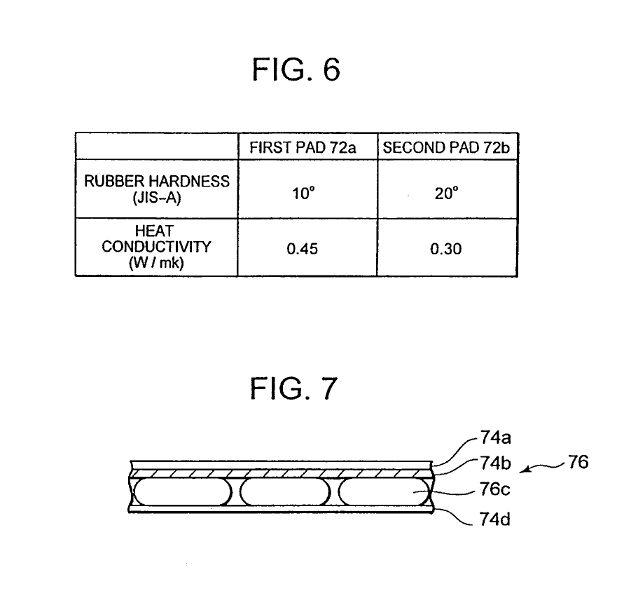

The pressure pad 72 is formed of, for example, a heat-resistant silicone sponge or silicone rubber, and includes, for example, a fluororesin mold release layer on a surface thereof. For example as shown in FIGS. 5 and 6, the pressure pad 72 includes a first pad 72a and a second pad 72b having different material properties from each other.

In a conveying direction of the sheet P in an arrow s direction, the first pad 72a of the pressure pad 72 on the upstream side relative to the conveying direction of the sheet P has the following material properties: the rubber hardness (JIS-A) according to the JIS standard is 10° ; and the heat conductivity (W/mK) according to the JIS standard is 0.45. The second pad 72b on the downstream side has the following material properties: the rubber hardness (JIS-A) according to the JIS standard is 20°; and the heat conductivity (W/mK) according to the JIS standard is 0.30. The first pad 72a on the upstream side is higher in rubber hardness and lower in heat conductivity than the second pad 72b on the downstream side. A stay 73 supports the pressure pad 72 and fixes the pressure pad 72 inside the fixing belt 60.

The press roller 61 includes, for example, a heat-resistant silicone sponge or silicone rubber layer around a metal core, and includes a PFA (fluororesin) mold release layer on a surface thereof. A press roller frame 80 supporting the press roller 61 includes a supporting point 80a. The press roller frame 80 rotates at the supporting point 80a relative to a fixing belt frame 90 supporting the fixing belt 60. The press roller 61 includes a pressure changing mechanism 87 which adjusts pressure of the press roller 61 applied to the pressure pad 72. The pressure changing mechanism 87 includes a cam 81, a bearing 82, and a pressure spring 85. The pressure spring 85 applies pressure to the press roller 61 toward an arrow r direction.

The cam 81 is elliptical and includes a cam surface 83a which is far from a rotational center 81a and a cam surface 83b which is close thereto. When the cam surface 83b close to the rotational center 81a of the cam 81 is in contact with the bearing 82, the pressure of the nip is high. When the cam surface 83a far from the rotational center 81a of the cam 81 is in contact with the bearing 82, the press roller frame 80 rotates in an arrow t direction against the force of the pressure spring 85 in the arrow r direction.

When using the fixing unit 45, the cam surface 83b of the cam 81 close to the rotational center 81a is in contact with the bearing 82, whereby the pressure spring 85 applies a high pressure to the press roller 61 toward the pressure pad 72. When not using the fixing unit 45, the cam surface 83a of the cam 81 far from the rotational center 81a is in contact with the bearing 82. The press roller frame 80 rotates in the arrow t direction, and the pressure of the press roller 61 on the pressure pad 72 is reduced, which prevents permanent set of the press roller 61.

The press roller frame 80 fixedly supports the separation blade 64. When using the fixing unit 45, the separation blade 64 faces the fixing belt 60 along the pressure pad 72 which is deformed by the high pressure of the press roller 61. When not using the fixing unit 45, if the pressure of the press roller 61 on the pressure pad 72 is reduced, the deformed pressure pad 72 is restored to its original shape. When the pressure pad 72 is restored to its original shape, the separation blade 64 rotates in the arrow t direction with the press roller frame 80, thereby moving apart from the pressure pad 72. When the pressure pad 72 is restored to its original shape, the separation blade 64 is not in contact with the fixing belt 60 at a tip. For reliably separating the sheet P upon separation, the separation blade 64 can move the tip thereof close to the fixing belt 60. Upon separation, the tip of the separation blade 64 maintains the gap relative to the fixing belt 60 at 0.1 to 0.4 mm, for example.

The IH coil 70 includes a magnetic core 70a and a coil 71. The magnetic core 70a enhances a magnetic field induced by the coil 71. The coil 71 has first coils 71a which generate a magnetic flux in the entire length of the fixing belt 60 in its longitudinal direction. The coil 71 has, on both sides of the fixing belt 60 in the longitudinal direction, second coils 71b whose current directions are opposite from those of the first coils 71a and which cancel the magnetic flux of the first coil 71a.

The coil 71 uses, for example, a litz wire formed of a bundle of 16 steel wire materials each having a wire diameter of 0.5 mm and covered with heat-resistant polyamide imide as an insulating material. By using the litz wire, the wire diameter can be made smaller than the penetrating depth, making it possible to effectively flow AC current.

High-frequency current is applied to the first coil 71a to generate a magnetic flux, so that eddy-current is generated in the heat generating layer 60b of the fixing belt 60. The eddy-current and the resistance of the heat generating layer 60b generate Joule heat, which heats the surface of the fixing belt 60 in the entire length in the longitudinal direction. The first coil 71a is excited to fix the sheet P having a width of the “A4” vertical size (297 mm) according to the JIS standard, for example.

When the first coil 71a and the second coil 71b are excited, the second coil 71b cancels the excitation of the first coil 71a. The first coil 71a and the second coil 71b are excited to fix the sheet P having a width of the “A4” horizontal size (210 mm) according to the JIS standard, for example.

The heat generating layer 60b of the fixing belt 60 is made to have a low heat capacity and reduced in thickness for enabling rapid start-up. The thickness of the heat generating layer 60b of the fixing belt 60 is smaller than a skin depth at a frequency applied to the IH coil 70. The magnetic flux of the IH coil 70 is not effectively utilized in the heat generating layer 60b, and part thereof passes through the heat generating layer 60b.

The auxiliary heat generating member 74 generates heat due to the magnetic flux passed through the heat generating layer 60b of the fixing belt 60, thereby achieving effective utilization of energy. As shown in FIG. 4 for example, the auxiliary heat generating member 74 includes, from the inner peripheral surface side of the fixing belt 60, a fluororesin mold release layer 74a with a thickness of 15 μm, a heat generating layer 74b with a thickness of 0.2 μm as a second metal heat generating layer, an aluminum heat equalizing layer 74c with a thickness of 0.5 mm, and a white PFA resin protective layer 74d with a thickness of 10 μm. The auxiliary heat generating member 74 keeps the fixing belt 60 warm from the inner peripheral side, thereby preventing the temperature of the fixing belt 60 from dropping.

The second heat generating layer 74b is formed of an inductively heatable metal layer such as of, for example, nickel, stainless steel, or aluminum. Alternatively, a magnetic shunt metal having a Curie point of 230° C., for example, may be used for the second heat generating layer 74b for preventing abnormal heat generation. Due to the magnetic flux of the coil 71 passed through the heat generating layer 60b of the fixing belt 60, eddy-current is generated in the second heat generating layer 74b. The auxiliary heat generating member 74 generates heat due to the Joule heat generated by the eddy-current and the resistance of the second heat generating layer 74b.

The heat equalizing layer 74c equalizes the temperature of the auxiliary heat generating member 74 in a direction perpendicular to the running direction of the fixing belt 60. For the heat equalizing layer 74c, a material having good heat conductivity, such as copper or aluminum for example, is used. Alternatively as shown in FIG. 7, a functional material such as a heat pipe 76c, for example, may be used as the heat equalizing layer to form an auxiliary heat generating member 76.

The heat equalizing layer 74c is disposed in a region of the auxiliary heat generating member 74 where the heat generating layer 74b generates heat due to the magnetic flux of the coil 71. The heat equalizing layer 74c equalizes the temperature between the central portion and sides of the auxiliary heat generating member 74 when the temperature difference between the central portion and sides becomes great, in the region of the auxiliary heat generating member 74 where the heat is generated by the magnetic flux of the coil 71. The heat equalizing layer 74c is not effective when it is disposed in a region other than the region of the auxiliary heat generating member 74 where the heat is generated by the magnetic flux of the coil 71. By disposing the heat equalizing layer 74c only in the effective region, the price of the auxiliary heat generating member 74 is reduced.

The protective layer 74d protects the heat equalizing layer 74c and the heat generating layer 74b. The protective layer 74d has a function of preventing heat reflection, thereby protecting the members provided inside the fixing belt 60. The protective layer 74d prevents the transfer of heat to the members inside the fixing belt 60.

The auxiliary heat generating member 74 is situated along the rotational direction of the fixing belt 60 in an arrow u direction from a position covering the pressure pad 72 to a region facing a downstream end of the IH coil 70. The auxiliary heat generating member 74 has a gap of about 1 mm, for example, from the inner periphery of the fixing belt 60. Because of the gap between the auxiliary heat generating member 74 and the fixing belt 60, the auxiliary heat generating member 74 does not apply a drive load to the fixing belt 60.

The auxiliary heat generating member 74 sticks firmly to the pressure pad 72 with an adhesive having a good heat conductive property, for example, to thereby heat the pressure pad 72. The stay 73 supports the pressure pad 72 via the auxiliary heat generating member 74. The auxiliary heat generating member 74 and the stay 73 are fixed to each other by welding or screwing.

The auxiliary heat generating member 74 is in contact with the inner periphery of the fixing belt 60 at a separation position 79 where the auxiliary heat generating member 74 faces the tip of the separation blade 64. A projecting portion 77 is formed in the auxiliary heat generating member 74, and the projecting portion 77 is brought into contact with the fixing belt 60. A tip of the projecting portion 77 has a curvature. The projecting portion 77 faces the tip of the separation blade 64 at the center of the curvature of the tip. By bringing the projecting portion 77 into contact with the fixing belt 60, the gap between the fixing belt 60 and the tip of the separation blade 64 is maintained constant. While maintaining the gap between the fixing belt 60 and the tip of the separation blade 64, the tip of the separation blade 64 moves closer to the fixing belt 60. The separation blade 64 moves the tip thereof closer to the fixing belt 60 to reliably separate the sheet P having an image with less empty space at the top. Since the projecting portion 77 includes the mold release layer 74a on the surface, the projecting portion 77 reduces the influence of friction on the fixing belt 60.

The auxiliary heat generating member 74 includes a temperature sensor 78 at the inner periphery in the region where the heat generating layer 74b generates heat. The temperature sensor 78 includes a first sensor 78a which detects the temperature of the center of the auxiliary heat generating member 74, and a second sensor 78b which detects the temperature of the side of the auxiliary heat generating member 74. The first sensor 78a and the second sensor 78b input the detected results to a main body control section 10 which controls the MFP 1.

The main body control section 10 controls the fixing unit and others along with an increase in temperature of the side of the auxiliary heat generating member 74 when, for example, a small-sized sheet is continuously passed. When the temperature of the side of the auxiliary heat generating member 74 increases, the main body control section 10 reduces, for example, cpm (copies per minute; the number of prints per minute) of the MFP 1, or performs a Wait control for the MFP 1.

The infrared temperature sensor 67 inputs the detected result to the main body control section 10. The main body control section 10 includes an IH control portion 10a which controls application of high-frequency current to the IH coil 70 and a drive control portion 10b which controls pressure adjustment or rotation drive of the press roller 61.

When printing starts, the drive control portion 10b controllably rotates the cam 81 of the fixing unit 45, thereby bringing the cam surface 83b close to the rotational center 81a of the cam 81 into contact with the bearing 82. With the spring force of the pressure spring 85, the press roller frame 80 rotates in the arrow r direction. The press roller 61 applies a high pressure to the pressure pad 72. The separation blade 64 supported by the press roller frame 80 rotates in the arrow r direction, so that the tip thereof is disposed at the separation position. The drive control portion 10b rotates the press roller 61 in an arrow q direction, so that the fixing belt 60 rotates following the press roller in the arrow u direction.

When the fixing belt 60 rotates following the press roller 61, the auxiliary heat generating member 74 is spaced apart from the inner periphery of the fixing belt 60 excluding the projecting portion 77. A drive load caused by the contact with the auxiliary heat generating member 74 does not occur in the fixing belt 60. The fixing belt 60 is driven to rotate stably.

The IH control portion 10a excites the coil 71 according to the size of the sheet P. The IH control portion 10a feedback-controls the IH coil 70 based on the detected result of the infrared temperature sensor 67 to keep the fixing belt 60 at a fixing temperature. The magnetic flux of the coil 71 generates eddy-current in the heat generating layer 60b of the fixing belt 60, whereby the fixing belt 60 is heated. Further, the magnetic flux of the coil 71 passed through the heat generating layer 60b generates eddy-current in the heat generating layer 74b of the auxiliary heat generating member 74, whereby the auxiliary heat generating member 74 is heated.

The heat of the auxiliary heat generating member 74 conducts to the fixing belt 60 via the gap to prevent the temperature drop of the fixing belt 60. The auxiliary heat generating member 74 conducts heat to the pressure pad 72 via the adhesive to heat the pressure pad 72. The pressure pad 72 heats the fixing belt 60 from its inner periphery at the position of the nip 63 to keep the fixing belt 60 warm. When fixing, the fixing belt 60 loses heat to the sheet. For example, when fixing a thick paper sheet, the fixing belt 60 loses a large amount of heat. When fixing a thick paper sheet, even when the fixing belt 60 is heated by the IH coil 70 after passing through the nip, the recovery temperature of the fixing belt 60 sometimes varies from cycle to cycle. When the recovery temperature of the fixing belt 60 varies from cycle to cycle, the temperature variations from cycle to cycle appear as gloss variations of a fixed image. The fixing belt 60 is auxiliarily heated by the pressure pad 72 to prevent the gloss variations from cycle to cycle of the fixing belt.

The sheet P having a toner image formed thereon by the transfer unit 44 passes through the nip 63 in the arrow s direction. The pressure pad 72 causes the sheet P to closely attach to the fixing belt 60 in a region of the first pad 72a having a low rubber hardness and a high heat conductivity, thereby sufficiently heating the toner image to enhance a fixing property. The pressure pad 72 easily separates the sheet P from the fixing belt 60 at a location where the sheet P exits the nip 63, in a region of the second pad 72b having a high rubber hardness and a low heat conductivity, which reduces the cooling time of the toner image after fusing. When the cooling time of the toner image fused when fixing is short, the sheet P can obtain a highly glossy fixed image.

Because of the passage of the sheet P, the fixing belt 60 loses temperature. However, the auxiliary heat generating member 74 keeps the fixing belt 60 warm from its inner periphery. Moreover, the pressure pad 72 heats the fixing belt 60 from the inner periphery.

When the sheet P passing in the arrow s direction exits the nip 63, the tip of the separation blade 64 separates the sheet P from the fixing belt 60. At a position facing the tip of the separation blade 64, the projecting portion 77 of the auxiliary heat generating member 74 is in contact with the fixing belt 60. The tip of the separation blade 64 can easily maintain the gap relative to the fixing belt 60, and the tip of the separation blade 64 can be moved close to the fixing belt 60. The separation blade 64 reliably separates the sheet P having an image with less empty space.

After separating the sheet P, the fixing belt 60 is heated again by the IH coil 70 while being kept warm by the auxiliary heat generating member 74.

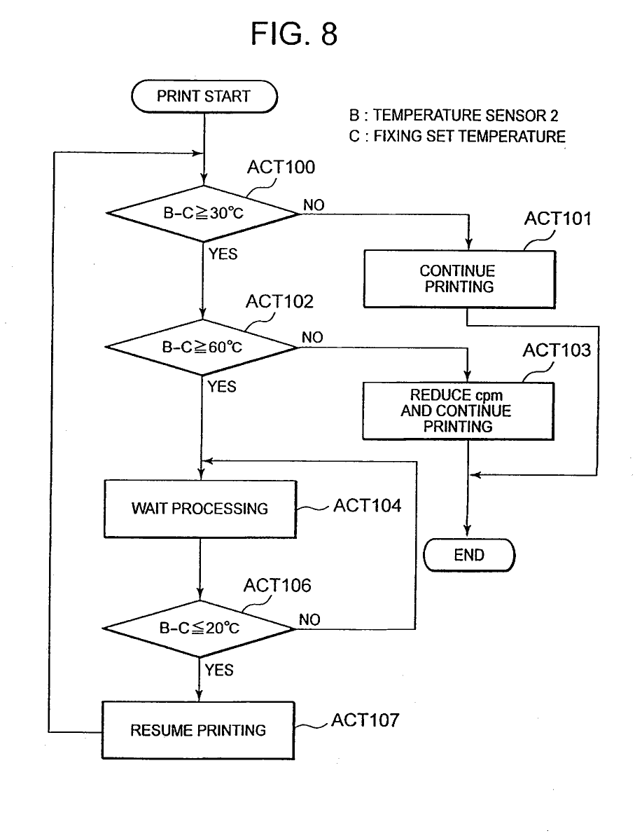

When the temperature of the side of the auxiliary heat generating member 74 of the fixing unit 45 increases in fixing, the operation of the MFP 1 is controlled. For example, when the sheet P having a small size is continuously passed, the IH coil 70 excites also the second coils 71b to cancel the heat generation on both sides of the fixing belt 60. The auxiliary heat generating member 74 includes the heat equalizing layer 74c, with which the auxiliary heat generating member 74 equalizes the temperature between the center and sides thereof. When the temperature of the side of the auxiliary heat generating member 74 increases regardless of the equalization of the temperature of the auxiliary heat generating member 74, the MFP 1 is controlled according to a flowchart in FIG. 8.

In FIG. 8, the detected result of the second sensor 78b at the side of the auxiliary heat generating member 74 is defined as (B) , while the fixing set temperature is defined as (C). It is determined whether the temperature (B) of the side of the auxiliary heat generating member satisfies the relation of (B)−(C)≧30° C. when continuously fixing the sheet P having a small size. If determining that the relation of (B)−(C)≧30° C. is not satisfied (No in ACT 100), the main body control section 10 continues printing in the MFP 1 (ACT 101). If the temperature of the side of the auxiliary heat generating member 74 increases greatly, and the relation of (B)−(C)≧30° C. is satisfied (Yes in ACT 100) , the main body control section 10 proceeds to ACT 102.

It is determined whether the temperature (B) of the side of the auxiliary heat generating member 74 satisfies the relation of (B)−(C)≧60° C. If determining that the relation of (B)−(C)≧60° C. is not satisfied (No in ACT 102) , the main body control section 10 reduces cpm in the MFP 1 and continues printing (ACT 103). If the temperature of the side of the auxiliary heat generating member 74 further increases greatly, and the relation of (B)−(C)≧60° C. is satisfied (Yes in ACT 102) , the main body control section 10 performs the Wait control for the MFP 1 (ACT 104) . The main body control section 10 determines whether the relation of (B)−(C)≦20° C. is satisfied. If determining that the relation of (B)−(C)≧20° C. is satisfied (Yes in ACT 106) , the main body control section 10 resumes printing at a normal speed in the MFP 1 (ACT 107) . If determining that the relation of (B)−(C)≦20° C. is not satisfied, the main body control section 10 returns to ACT 104.

When the temperature of the side of the auxiliary heat generating member 74 increases, the main body control section 10 may perform the Wait control for the MFP 1 without reducing cpm of the MFP 1.

When printing completes, the drive control portion 10b controllably rotates the cam 81 of the fixing unit 45, thereby bringing the cam surface 83a far from the rotational center 81a of the cam 81 into contact with the bearing 82. The press roller frame 80 rotates in the arrow t direction against the spring force of the pressure spring 85. The press roller 61 reduces the pressure on the pressure pad 72. The deformed pressure pad 72 is restored to its original shape, and the separation blade 64 moves away from the fixing belt 60 with the press roller frame 80.

The tip of the separation blade 64 moves close to the fixing belt 60 when fixing to reliably separate the sheet P. After the completion of fixing, the tip of the separation blade 64 reliably moves away from the fixing belt 60.

According to the embodiment, the auxiliary heat generating member 74 which generates heat using the magnetic flux passed through the fixing belt 60 keeps the fixing belt 60 warm. The auxiliary heat generating member 74 heats the pressure pad 72, and the pressure pad 72 heats the fixing belt 60. Gloss variations caused by temperature variations from cycle to cycle of the fixing belt 60 are prevented. Since the auxiliary heat generating member 74 has the gap relative to the fixing belt 60, a drive load is not applied to the fixing belt 60. The fixing belt 60 stably rotates. At the position facing the tip of the separation blade 64, the projecting portion 77 of the auxiliary heat generating member 74 is in contact with the fixing belt 60, so that the gap between the fixing belt 60 and the tip of the separation blade 64 is maintained constant. Since the gap between the fixing belt 60 and the tip of the separation blade 64 is maintained, the tip of the separation blade 64 can be moved closer to the fixing belt 60 to reliably separate the sheet P.

According to the embodiment, the first pad 72a on the upstream of the conveying direction of the sheet P is made to have a low rubber hardness and a high heat conductivity. The second pad 72b on the downstream of the conveying direction of the sheet P is made to have a high rubber hardness and a low heat conductivity. The pressure pad 72 enhances the fixing property of the toner image on the sheet P, enhances the separability of the sheet P from the fixing belt 60, and improves the glossiness of the toner image.

According to the embodiment, when the temperature of the side of the auxiliary heat generating member 74 increases, cpm of the MFP 1 is reduced, and further the Wait control is performed for the MFP 1. The fixing belt 60 is kept uniformly warm, and uniform heating of the fixing belt 60 due to the pressure pad 72 is achieved.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form o the apparatus and methods described herein may be made without departing from the spirit of the inventions. The accompanying claims and there equivalents are intended to cover such forms of modifications as would fall within the scope and spirit of the invention.

What is claimed is:

1. A fixing device comprising:
a fixing belt comprising a first metal heat generating layer;
a pressure section facing an outer periphery of the fixing belt;
an induction current generating coil situated near a peripheral surface of the fixing belt;
a nip forming member situated inside the fixing belt and applying pressure to the fixing belt toward the pressure section; and
an auxiliary heat generating member situated inside the fixing belt, comprising a second metal heat generating layer, extending to a position facing the induction current generating coil, and comprising a projecting portion contacting the fixing belt.

2. The device according to claim 1, wherein the auxiliary heat generating member connects to the nip forming member.

3. The device according to claim 2, wherein the auxiliary heat generating member extends from the position facing the induction current generating coil through the projecting portion to connect to the nip forming member.

4. The device according to claim 1, wherein the auxiliary heat generating member generates heat due to a magnetic flux of the induction current generating coil.

5. The device according to claim 1, wherein the projecting portion faces a tip of a separation member situated on the outer periphery of the fixing belt.

6. The device according to claim 1, wherein the second metal heat generating layer has a magnetic material layer.

7. The device according to claim 1, wherein the auxiliary heat generating member comprises a heat equalizing layer stacked on the second metal heat generating layer.

8. The device according to claim 1, wherein the auxiliary heat generating member comprises a gap between the auxiliary heat generating member and the fixing belt at a portion other than the projecting portion.

9. The device according to claim 1, wherein the auxiliary heat generating member comprises a heat reflection preventing layer on the opposite surface to the surface facing the induction current generating coil.

10. The device according to claim 1, further comprising a temperature sensor detecting temperature of the auxiliary heat generating member.

11. An image forming apparatus comprising:
an image forming section forming an image on a recording medium; and
a fixing device comprising a fixing belt comprising a first metal heat generating layer, a pressure section facing an outer periphery of the fixing belt, an induction current generating coil situated near a peripheral surface of the fixing belt, a nip forming member situated inside the fixing belt and applying pressure to the fixing belt toward the pressure section, and an auxiliary heat generating member situated inside the fixing belt, comprising a second metal heat generating layer, extending to a position facing the induction current generating coil, and comprising a projecting portion contacting the fixing belt.

12. The apparatus according to claim 11, wherein the auxiliary heat generating member connects to the nip forming member.

13. The apparatus according to claim 12, wherein the auxiliary heat generating member extends from the position facing the induction current generating coil through the projecting portion to connect to the nip forming member.

14. The apparatus according to claim 11, wherein the auxiliary heat generating member generates heat due to a magnetic flux of the induction current generating coil.

15. The apparatus according to claim 11, wherein the auxiliary heat generating member comprises a heat equalizing layer stacked on the second metal heat generating layer.

16. The apparatus according to claim 11, wherein the auxiliary heat generating member comprises a gap between the auxiliary heat generating member and the fixing belt on an upstream and a downstream of the projecting portion in a running direction of the fixing belt.

17. A fixing method comprising:
heating a fixing belt by generate induced current, the fixing belt applies pressure toward a pressure section and forms a nip between the fixing belt and the pressure section; and
generating heat an auxiliary heat generating member with the induced current passed through the fixing belt, the auxiliary heat generating member situated inside of the fixing belt and contacted a part of the fixing belt.

18. The method according to claim 17, wherein the auxiliary heat generating member heats a nip forming member applying pressure to the fixing belt from inside the fixing belt toward the pressure section.
